(19) United States
(12) Patent Application Publication
(10) Pub. No.: US 2009/0314615 A1
(43) Pub. Date: Dec. 24, 2009

(54) MOTOR OPERATOR FOR SWITCHGEAR FOR MAINS POWER DISTRIBUTION SYSTEMS

(76) Inventors: Bruno Christensen, Nordborg (DK); Glenn Smith, Nottinghamshire (GB); Caspar P. Laugesen, Sydals (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/312,219

(22) PCT Filed: Oct. 31, 2007
(86) PCT No.: PCT/DK2007/000465

§ 371 Date: Apr. 30, 2009

(30) Foreign Application Priority Data
Oct. 31, 2006 (DK) PA 2006 01405

(51) Int. Cl. H01H 3/00

(52) U.S. Cl. 200/17 R

(57) ABSTRACT

A motor operator for switchgear for mains power distribution systems, where the switchgear comprises a closed cabinet 1 with an operating shaft 2 protruding there from. The operating shaft is rotatable at least between two positions and has a coupling part. The motor operator 6 comprises a housing 10, which is mountable on the external surface of the switchgear housing, and a rotatable connection shaft connected to an electric motor drive mechanism. It has a first coupling part to fit with the coupling part of the switchgear in a longitudinal axial sliding and non-rotational interlocking manner. Further, it has a second coupling part extending from the housing to operate the switch manually. The operator further comprises a control unit 8 with a connection rack, one or more power supplies, besides from a battery 9, and one or more communication facilities 9, such that the motor operator appears self-contained with all necessary facilities ready to operate when installed.

### BACKGROUND OF THE INVENTION

1. Field of the Invention

The invention relates to a motor operator for opening or closing contacts of switchgear adapted for use in mains power distribution systems (usually 10 kV-36, 5 kV) such as public power distribution. The motor of the operator may be activated either locally or remotely to open or close the contacts of the switchgear. Alternatively, a drive element normally coupling the motor to the contact operating shaft is selectively removable so that a wrench may be used to manually open and close the contacts in case of failure of the motor operator or as a safety precaution.

2. Description of the Prior Art

Underground or pole mounted electrical transmission and distribution systems include a main service line leading from a sub-station with a number of individual distribution lines connected to the main line along this. It is often the practice, particularly where power is supplied to a user entity, such as a discrete residential area, industrial area or shopping area, to provide switchgear in each of the lateral distribution lines connected to the main line in order to allow selective de-energization of the lateral distribution line without the necessity of de-energizing all of the lateral distribution lines. Switchgear conventionally includes electrical, movable contacts, which may be opened and closed by maintenance personnel in case of fault in or maintenance of a distribution line. In a particularly useful type of switchgear, the contacts are mounted under oil or in an inert gas atmosphere.

Generally, the contacts of switchgear require snap action opening and closing mechanisms to minimize arcing and assure a positive closing of the contacts. Actuation of the switch operating mechanism has normally been accomplished manually requiring service personal to locate and travel to the switchgear in question. Recently, there has been increased interest in switch contact actuating mechanisms which are motor operated and can be activated at remote locations as well as manually locally. In some cases, motor operators have been installed within the switchgear cabinet itself for powered actuation of the opening and closing mechanism. By design, these motor operators are not suitable for installation on a retrofit basis on an external side of an existing switchgear cabinet. Moreover, most of the available motor gear operators are relatively expensive, both in terms of cost for various components as well as expenses for installation of the same. Furthermore, these motor operators do not readily lend themselves to manual actuation in the event of motor failure or in the event that the operator desires to open the switch contacts by hand. Moreover, remote control is difficult or even impossible as the cabinet of the switchgear is a closed steel locker.

As a consequence of the fact that it is almost impossible to incorporate a motor operator in a switchgear cabinet there is an increased interest in motor operators that could be mounted externally to the cabinet of the switchgear. In this respect it should be noted that it is not allowed to make any holes in the cabinet or make weldings, which renders the mounting very difficult. It should also be considered that in most cases, the motor operator should not only be weather proof but also secured against unauthorized intrusion. Further, it should be fully operable under all and extreme weather conditions and operate in a reliable manner.

An example of a motor operator to be mounted externally on a switch gear is dealt with in U.S. Pat. No. 4,804,809, said motor operator may even be mounted as a retrofit unit. The motor operator is composed of an assembly of individual elements mounted in a housing, necessitating a tedious dismounting of the connection between the motor operator and the switchgear for manually operating the switchgear. Further, the motor operator has to be designed for each individual type of switchgear. This renders the motor operator costly. All the electrical equipment is installed individually and remotely from the motor operator. This also goes for the motor operator dealt with in U.S. Pat. No. 5,895,987. In GB 2 331 401 A it is the very nature that the mechanical and the electrical parts are separated to remotely control the motor operator via a cable connection.

Hence, there is a need for a motor operator which overcomes these and other problems associated with known devices.

### SUMMARY OF THE INVENTION

It is an object of the present invention to provide a motor operator which could be installed as a complete unit containing all necessary equipment to operate the switchgear locally as well as remotely.

This is accomplished in that the motor operator comprises a housing mountable on the external surface of the switchgear cabinet and containing a motor driven unit with coupling means for connection with the coupling means of the operating shaft of the switchgear. The coupling means being of the detachable type in the sense that they mate loosely with the coupling means on the operating shaft of the switchgear. Further, the motor operator comprises a least one rechargeable battery package such that it is operable independently of the distribution line. Moreover, the motor operator comprises a control unit with a connection rack for the motor driven unit, and at least one or more of the following power supplies: a cable connection to the distribution line, a solar panel, a wind turbine generator, at least one battery package. The exact make-up of the power supply depends on the exact geographical location of the switchgear; in sunny areas a solar panel is preferred and in windy environments a wind turbine is to be preferred, however a combination of more of the above mentioned power supplies cannot be excluded. The connection rack is also used for one or more of the following communication facilities: GSM/GPRS, Blue Tooth, a cable bound communication, such as Paknet (trademark of Vodafone), and a computer. The exact type of communication chosen depends on the facilities available in the specific geographical area. Furthermore, various I/Os are available like analog inputs, digital inputs or relay outputs.

The control unit itself is modular built in its own housing, with the interfaces as already mentioned. A main printed circuit board (pcb) with connectors and connections forms the backbone, where a pcb, in form of a system board, and a pcb containing the power supply, is connected by sliding the pcbs in the respective slots specifically designed for the purpose. This makes the system very flexible and easy to repair if a part is defective. Since it will be possible to replace the pcbs, one by one, it is possible in the future to upgrade the system to upcoming technologies, by simply replacing e.g. the system board with a new board if it is made in respect to the interfaces and connections. On the system board, auxiliary connectors formed as slots are placed for installation of optional modules for GSM/GPRS modem and Bluetooth.

The system board itself is equipped with a microcontroller with peripherals (I/O), memory, file system and software, for which the functionality will be explained.

During start-up of the system, the configuration file stored in the file system, is read by the Volatile Data Storage (VDS). The VDS is a register that always has an updated status on the systems static and dynamic data. The static data configures the system to fit the present switchgear with its equipment. The system's dynamic data is scanned by the peripheral input tasks and changes are sent to the VDS. For executing the logic, that defines the functionality of the switchgear, a system to emulate a PLC is used. Such a system is often referred to as a “soft PLC”. The soft PLC reads the relevant data from the VDS in regular cycles in order to determine what action to take, if any. For controlling the digital outputs, a field-programmable gate array (FPGA) is used. Time critical functions that are common for all types of switchgears are built into the FPGA. An example of this could be control systems for safety. If an error occurs or a situation is present where immediate action is needed, the FPGA immediately takes action to stop the ongoing task. This could be the situation, where the actuator is moving the shaft of the switchgear, and an input from a sensor indicates that the open/close position of the switchgear has been shifted to the desired position. Execution of independent tasks is isolated by use of an operating system. This way the soft PLC, the peripheral input, the peripheral output and the VDS can execute independently of each other. This build-up makes the system very flexible as the soft PLC can be programmed to fit specific demands or wishes from the customers. The build-up with the split between the soft PLC and the VDS reveals a long term solution for a platform that can be developed, renewed and tailored to match the demands that any customer may have to a piece of equipment for monitoring and controlling a switchgear system in a distribution system. During normal operation, the soft-PLC reads the VDS on a regular basis. If the input from the VDS shows that an action is needed, the corresponding dynamic data are communicated to the VDS. The VDS forwards the data to the peripheral outputs. This could be communicating a request of setting up the power supply to deliver the voltage needed for driving the actuators.

The VDS communicates to the PSU via a Modbus interface requesting the PSU to enable the respective outputs. When the PSU has performed the wanted action, it communicates back to the VDS that the output power is present. When the soft PLC reads the VDS, it finds that the voltage is present and commands the VDS to set the specific I/O that starts the actuator to drive the switchgear in the wanted direction. The specific output pin on the I/O will be active, and the actuator will be supplied. Several conditions though have to be fulfilled before the soft PLC will let the actuator move the position of the switchgear. The movement of the actuating means is limited to move the operating shaft of the switchgear between the two positions, open and close. Attached to the actuator, are position-switches that are connected to the input of the VDS, in order to decouple the power when a certain position is reached. In the practical example, the position switch in each of the ends of the distance of movement of the actuator is carried out by two after each other following magnetically activated switches with a latching effect. This means that when the first switch is reached it is activated and stays activated when the magnet moves over the switch and leaves it in the direction towards the next switch. When the next switch is reached this is activated too. The action from the VDS when the second switch is reached will be to immediately stop the actuator. When the actuator is driven back, the switches will be unlatched and thus no switches will be activated. In this intermediate position between the inner switches, the state of the switchgear cannot be trusted, but this state will normally last only a couple of seconds until the open/close state of the switchgear is changed. For this reason it should only be treated as a short transition between the valid positions. An example of the operation of the motor drive changing the open/close state of the switchgear is described as follows: the actuator is driven back in order to change the open/close state of the switchgear. When the switchgear's open/close state is changed, the first switch in the other position will be reached, and when the second switch is reached, the FPGA will immediately stop the actuator. Thus, the system will always give a true picture of the position of the switchgear. This is especially important when the switchgear is switched manually with the release function activated on the actuator. Using the release function of the actuator and manually operating the switchgear, the spindle nut will be free to rotate on the spindle. Since the switchgear shifting is made with a spring to rapidly move the switchgear position when a certain force is applied, the shifting positions of the shaft forms a curve with a large hysteresis. This rapid shifting ensures that the switchgear contacting means are always either open or closed and thereby avoids damage to the contacts and possibly welding of the contacts. The inner position switches will be adjusted so as to always show the position of the switchgear, but the outer position switches will only show that the actuator itself has driven the shaft to its outmost position. With this setup a solution, to overcome the clearance or play that will be a natural part of a mechanical system for operating a switch gear, is provided. Furthermore, the indications of the positions will because of the build-up with latching magnetic switches be updated even when the system is not powered. This means that when the power again is present, the true position of the switchgear can be read from the state of the magnetic switches, without any chance of the information being ambiguous. This new use of a magnetic switch with latching effect for an actuator overcomes the disadvantages that come with using a traditional magnetic or optical encoder for determining the position of the spindle nut during the travel of the spindle in the actuator, namely the missing ability to provide clear information on the position of the spindle nut during the travel of the spindle, when the supply to the control unit is lost or have been cut off. A traditional potentiometer of the linear or rotary type can be used as an alternative to the preferred embodiment but needs an analog input and means for converting the voltage level to a corresponding digital value to be compared with defined thresholds. Use of a potentiometer can also be applied to use of an actuator of the rotary type as a motor driven unit.

The system also features communication means for short and wide range remote. Please note that the communication means described are subject to standards or trademarks. The short range remote system is consisting of a terminal which preferably could be a pocket pc to be connected to the system via USB or a Bluetooth connection. The wide range remote system comprises a terminal, preferably a stationary pc, coupled to exchange information with the switchgear system via a cable connection or wireless connection such as e.g. GSM/GPRS or Paknet. In case of using the DNP3 protocol, the information to display follows the matrix set-up in the DNP3 protocol and will be mapped to identify specific parameters in the system. An example hereof could be the open/close position of the switchgear which is equipped with its own unique identifier.

Via the Modbus protocol, it is possible to connect a variety of devices to the system. As an example both the USB interface and the Bluetooth interface are implemented by connecting the integrated circuits, specific for the purpose, to the VDS via a Modbus slave controller. Since the equipping of the system with USB and Bluetooth connections is made with respect to the wish for connecting a monitor to the system, a special interface for the soft PLC is made, and connects via the serial interface to the soft PLC. From the short range remote equipped terminal, it is possible to monitor the system and force an action or up- and download files to the system. One of the files that can be uploaded is the file that contains the list of events as well as measurements of the system performance. The file with logged data will at least specify the action, operator-id and timestamp. The logged data file can also be read by the wide range remote connection (Paknet, GPRS) via the DNP3 protocol. The dynamic and static data can also be read from the wide range remote. Downloadable files from the remote could be a new firmware or a new system-config file, or even new logic to be run in the soft PLC. The download and execution will typically be controlled from the short range remote.

Further developments of the system are foreseen, so the I/O will be able to adapt more devices along with the actuators.

In general the invention takes steps in order to make a more reliable and flexible system. The readout of data and status from the system should be reliable, and of high importance is that the system should be reliable and ready to operate even though the system might have been in a monitoring mode for several years, without any active tasks as e.g. operating the motor drive, but being exposed to ageing in general and ageing due to the environment. Algorithms are built into the system for testing the system's reliability. The battery state is determined by exercising the battery packs at a regular frequency. The exercise is made with a fully charged battery pack where a specific part (specific load in a specific period of time) of the energy is taken away from the battery, the voltage drop is checked and thus the remaining capacity can be calculated. If this value goes beyond a certain threshold a warning is issued, requiring the service to exchange the battery pack and certain actions like shifting the switchgear can be prohibited since the system can foresee that there will not be sufficient energy to perform the action. Similarly, it is possible to measure the state of the actuators by comparing the travels performed during the time, with the initial travels in terms of current consumption, time of operation and possibly other parameters that can picture the degradation of the actuator. In this way, it will be possible to determine when the actuator has to be replaced and also to require replacement of the actuator if the performance drops beyond a defined threshold.

The main reason for using remote controlled switchgears is to maintain a high degree of stability of the electrical distribution system. Since a stable power supply is a must for the society, the costs of a power cut can be tremendous. According to this, the power distributor might have to pay fees when a power cut appears depending on the influenced network and the down time. This makes it especially interesting for the distributor to safe proof the network and build up arrangements for fast recovering of faults. Normally the supply system is formed as a “ring” where the supply is fed both ways in the system, but broken at one of the switchgears in the system. This means that when a short circuit or cut of a cable occurs, the system can be configured to isolate the defective part and maintain the supply to the entire network. With the use of Fault Passage Indicators (FPI) that registers the passage of a fault through the Switchgears distributed in the system, it is made possible to determine the defective part of the distribution system. The position of the individual switchgear in the row of switchgears seen from one of the feeding points in the ring will enable the overall control system to sketch the roll out of the fault in the system and make a clear decision on what part of the system is defective. It will then be possible for the operator of the overall distribution system from his remote position to patch the stable connection by changing the position of some of the motor operated switchgears in the network and thus quickly recover from the error.

In case the switchgear is of the type where the contacts are located in a protective gas atmosphere, the motor operator also comprises a gas alarm. Expediently, the existing gas pressure gauge could be exploited using a laser device to read when the needle of the gauge exceeds an unallowable limited. In this manner intervention in the switchgear is avoided. Similarly, the motor operator, according to the invention, provides a magnificent freedom in designing the motor operator and not least in the installation process of the motor operator on the spot. There is the further rather important benefit that the motor operator, as a complete functional unit, could be tested before leaving the factory. This is rather essential as switchgears could be located at remote and rather inaccessible locations. Finally, it should be understood that the overall size of the motor operator could be relatively compact making it even more easy to mount on a switchgear. Due to the compact design the mounting means could also be smaller and of a more simple nature.

### BRIEF DESCRIPTION OF THE DRAWING

FIG. 1, a perspective view of a switchgear seen from the front,

FIG. 2, a perspective view of a linear actuator seen from the rear end,

FIG. 3, a longitudinal section through the linear actuator,

FIG. 4, an end cover in a perspective view of the enclosure of the linear actuator seen from the inside of the actuator,

FIG. 5, a cross section of the end cover,

FIG. 6, a circuit board inside the actuator shown in an exploded view,

FIG. 7, an enlarged cross section of the upper part of the motor operator showing the connection to the operating shaft of the contacts of the switch gear,

FIG. 8, a phantom drawing of the motor operator shown in an activated position with the contacts of the switchgear in an open position,

FIG. 9, a phantom drawing similar to FIG. 8, however, showing the motor operator in a none-activated position with the contacts of the switchgear in a closed position.

FIG. 10, a cross section of a sub-housing of the motor operator,

FIG. 11, a cross section of a further sub-housing of the motor operator,

FIG. 12, a cross section of a third sub-housing of the motor operator,

FIG. 13, a representation of the housings of the motor operator,

FIG. 14, a representation of the overall layout of the motor operator,

FIG. 15, a view of the build up of the control unit for the motor operator,

FIG. 16, a representation of the modular build up of the control unit with interfaces and

FIG. 17, an enlarged picture of the laser module to monitor the gas level gauge.

### DETAILED DESCRIPTION OF THE DRAWING

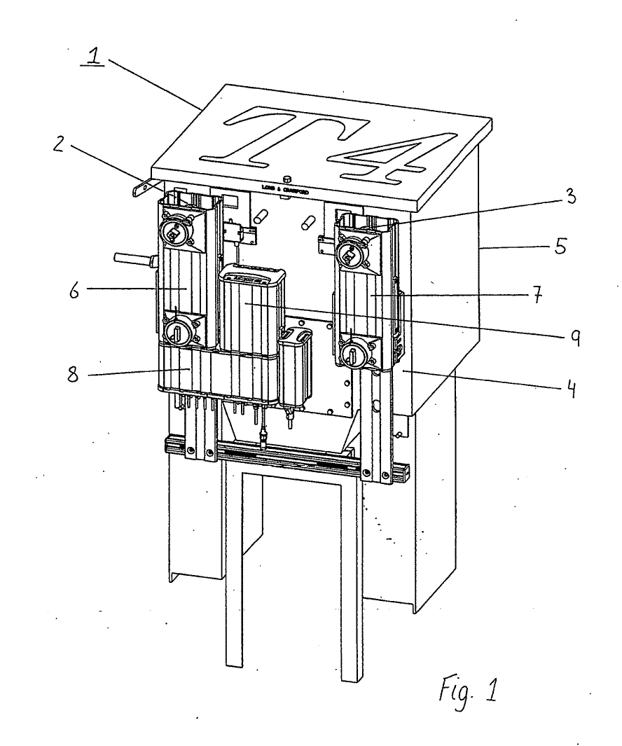

In FIG. 1 a switchgear 1 with to sets of electric contacts is shown operated by a rotary shaft ending in a dog 2, 3 at the front side 4 of the cabinet 5 of the switchgear. The electric contacts are controlled by the respective motor operators 6,7. As the motor operators are basically identical, only one is described in the following. The motor operator 6 on the left hand side of the switchgear is built together with a control unit 8 and a rechargeable battery package 9, which is common for the two motor operators.

The motor operator 6 comprises a housing 10 in the nature of an extruded aluminum profile 11 with end closures, not shown. The end closures are fixed to the profile 11 by means of screws received in screw channels in the profile.

In the housing 10 is located a linear actuator 12. The actuator comprises an enclosure 13 with a reversible electric motor 14 driving a spindle 15 through a multiple stage step down gear 16. The step down gear comprises a planetary gear and a gear train. An activation element 17 in the nature of a tubular piston is attached to a spindle nut 18 located on the spindle 15. The activation element 17 is telescopically guided in a guide tube 19. The actuator has a rear mounting 21 for mounting in the housing 10 of the motor operator.

The enclosure 13, which is made of moulded aluminium for strength purposes, has an end cover 13a which is mounted with screws, and the joint is moreover water-tight. The guide tube 19 is an extruded aluminium tube having an essentially square cross-section. On its one side, the guide tube 19 is equipped with two longitudinal grooves 19a, 19b, which is used for mounting end stop switches 22a, 22b. The end stop switches are read switches, triggered by a magnet carried by the spindle nut 18. Accordingly, the stroke of the actuator could easily be adjusted by moving the end stop switches. A front mounting, here a piston rod eye 23, is secured in the end of the activation element. The end stop switches used in the preferred embodiment are not the standard reed switches used in traditional actuator systems, but a new type as the nature of the switching of a switchgear requires special preconditions for the detecting of the position of the switchgear, especially in this case where the actuator features a release function. The use of a special end stop switch, acting as a position switch, is described further in the description of the control unit that follows later in this document.

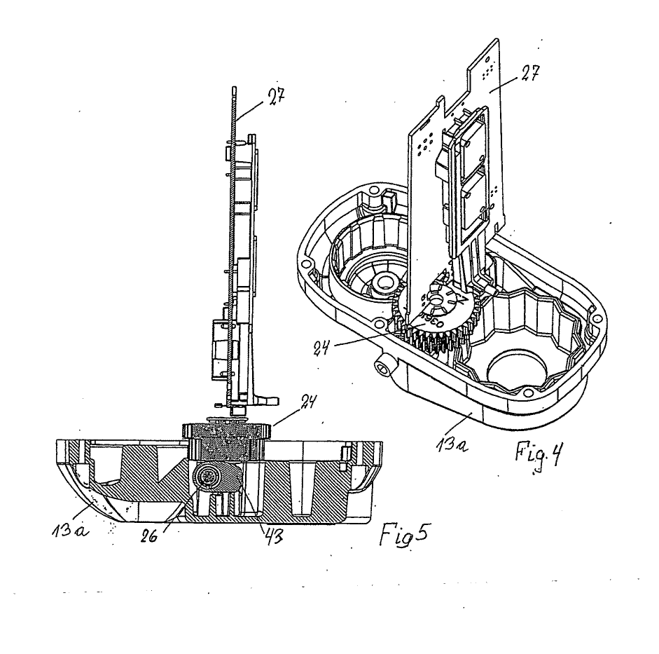

In FIGS. 4 and 5 the end cover 13a of the enclosure 13 is shown in greater details. Among others the first gear wheel 24 following the planetary gear 25 is shown. Said gear wheel 24 is arranged in a longitudinal displaceable manner. The displacement could be effected with an eccentric 43 on a swivel axis 26. When displaced, the gear wheel 24 disengages the gear train and accordingly the spindle 15 is decoupled from the motor 14 and the planetary gear 25 and could thus be driven manually.

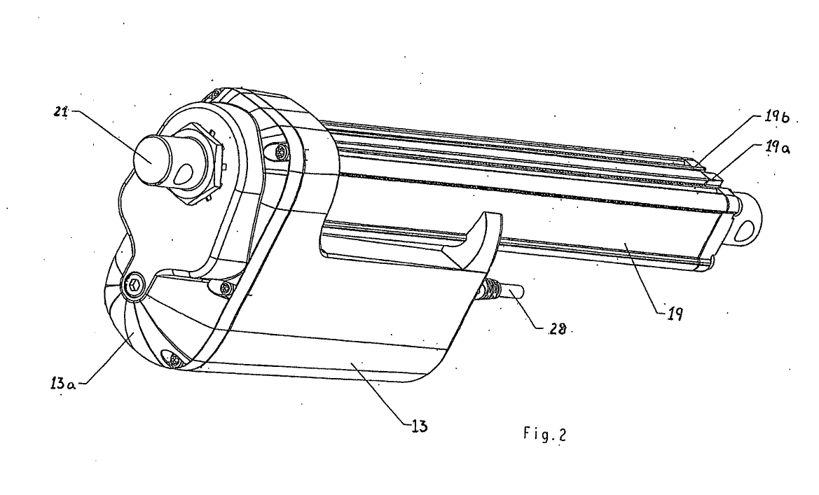

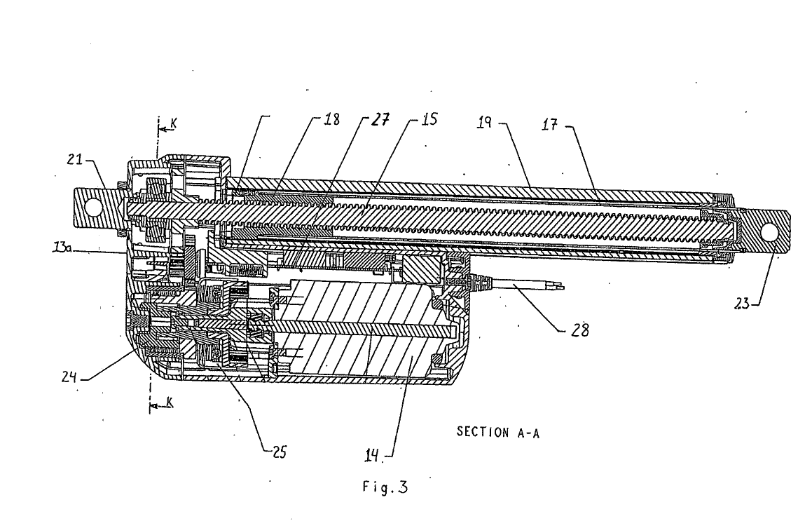

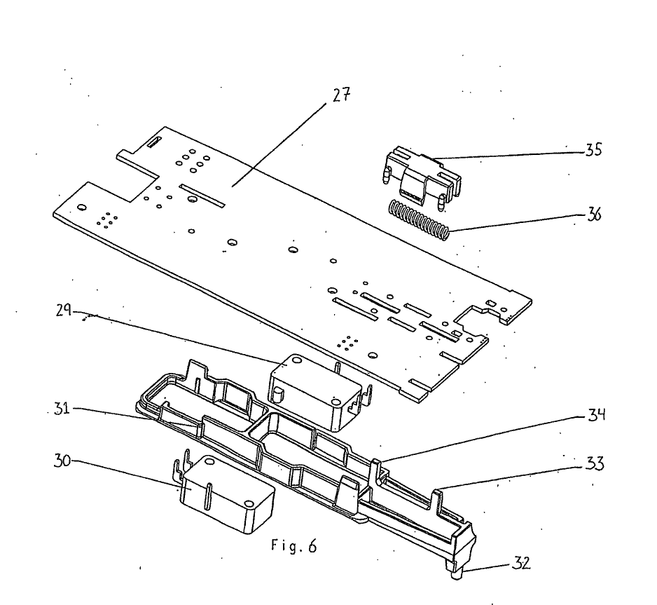

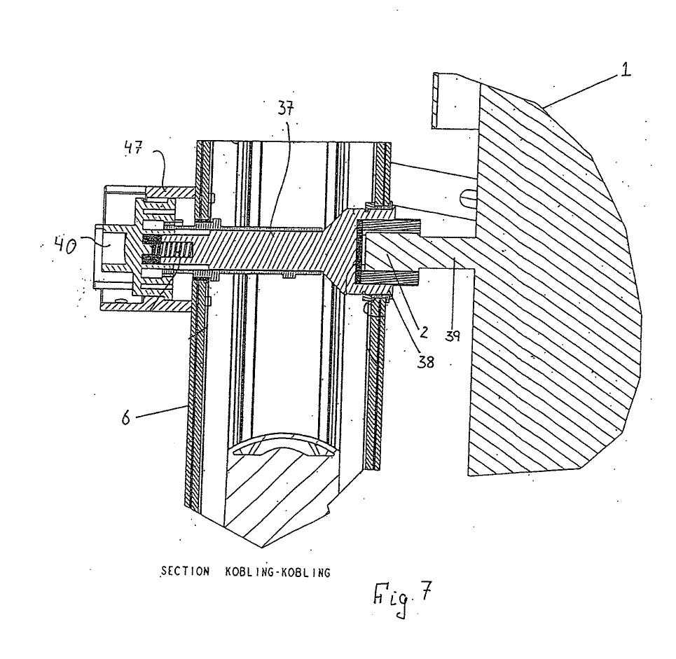

A printed circuit board 27 with all the components and circuits necessary for the control of the actuator is inserted into the enclosure below the motor 14 (FIG. 3). The printed circuit board is arranged such that the actuator may run on a DC as well as an AC power supply positioned outside the actuator. A bridge having four FET transistors is used for reversing the direction of rotation of the motor. The printed circuit board extends to the front end of the enclosure, which has a gate at each side for a cable 28 (FIG. 2). In connection with the gates, the printed circuit board has a socket for the cables. The one cable is a power supply cable, while the other is a control cable for a PLC control in the control unit 8. At the circuit board two switches 29, 30 are arranged. A slide element 31 is arranged around the switches, which are rectangular, said slide element being provided with two-frame-shaped openings, which guide toward the side of the switches, and which activate these in specific positions (FIG. 6). The slide has an angular leg 32, which extends down behind the displaceable gear wheel 24. When the gear wheel is displaced, it hits the leg 32 and pushes the slide 31 to activate the respective switch 30 in order to interrupt the power to the motor. The slide element 31 is kept in a neutral position in that it has two fingers 33, 34, which extend through a slot in the printed circuit board, on whose other side an elongate housing 35 is mounted, in which a slightly biased helical spring 36 is mounted between the ends. A slot is provided at both ends of the housing for the fingers of the slide element which engage the ends of the spring. The slide element is thereby kept in a neutral position by a single helical spring. When the slide element 31 is moved towards the rear end of the actuator, the spring 36 is compressed against the rear end of the housing by the finger 34 closest to the front end of the actuator, while the finger 33 closest to the rear end of the actuator is displaced in its slot away from the housing 35. When operating the eccentric 25 for engaging the gear wheel 24 the gear wheel leaves its innermost position and runs outwards, the spring tension ensures that the slide element 35 assumes a neutral position, and since the spring 36 is biased, the neutral position is determined uniquely. Accordingly, it is ensured that the power to the motor 14 is cut off when the spindle 15 is disengaged for manual operation.

At the upper end of the housing of the motor operator a connection shaft 37 is arranged at the end facing the switchgear designed with a socket 38 fitting the dog 2 at the end of the shaft 39 operating the contacts within the switchgear. The socket 38 is in a horizontal movement slid over the dog 2 and the socket and the dog is rotatably interconnected. The end of the connection shaft 37 is protruding from the housing 6 and is fitted with a socket member 40 for manually operating by means of a wrench. The socket member 40 is resting in a base 47 mounted on the housing 6.

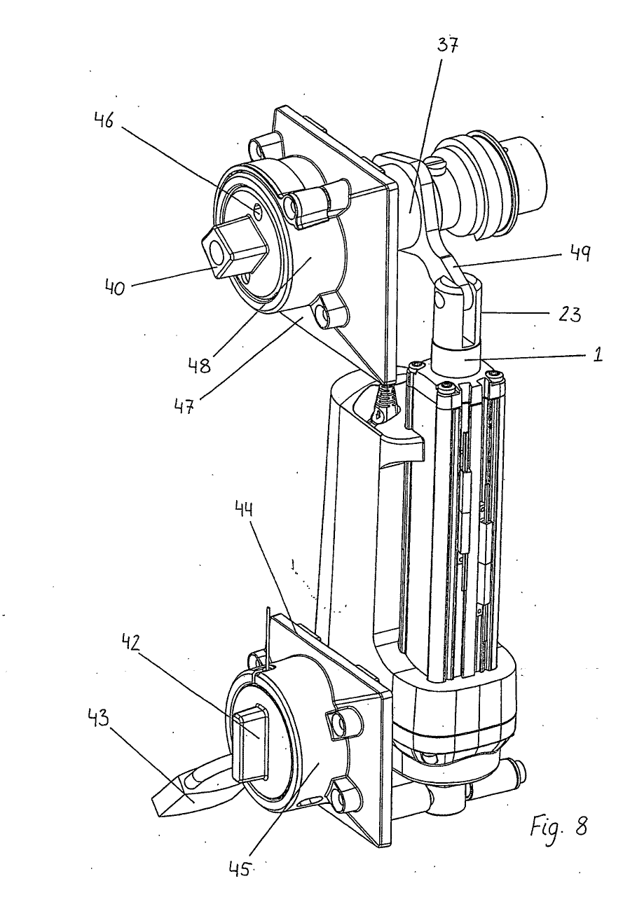

As it is apparent from FIG. 8, the release mechanism can be operated by a turnable knob 42 on the front side of the housing 6 of the engaging motor operator, the housing 6 not being shown in the figure. When turning the knob 42, the release mechanism is activated. The knob 42 could be barred with a pad-lock 43 for which purpose the knob is having a hole on the front. A base 44 for the knob is having a wall element 45. When the pad-lock is inserted into a hole in the wall element 45, the knob 42 is barred.

The socket member 40 of the connection shaft 37 has a similar barring arrangement. The socket 40 has a hole 46 in the front, and a mounting base 47 for the socket 40 is having a wall element 48 with a similar hole. When a pad-lock is inserted into a hole in the wall element 48 through the hole 46, the socket 40 is barred and thereby prevents the switchgear from being operated.

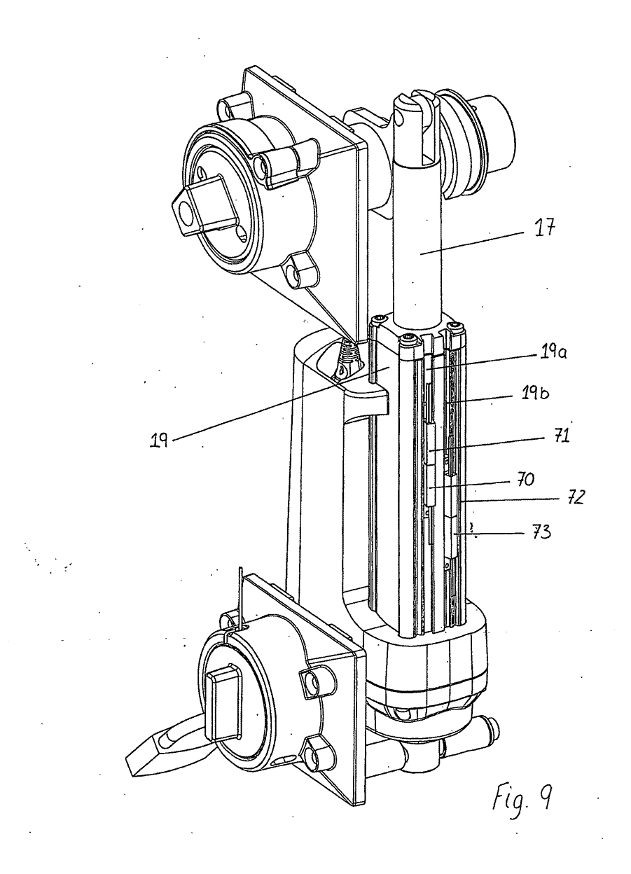

As it emerges from FIG. 8, the connection shaft 37 is connected to the front mounting 23 of the actuator with a lever arm 49 with a bolt through the piston eye and a corresponding hole in the lever arm 49. In FIG. 8 the activation element 17, the thrust rod of the actuator is shown in its retracted position corresponding thereto, that the contacts of the switchgear are in a closed position. In FIG. 9 the activation element 17 is shown in its outer expelled position corresponding thereto, that the contacts of the switchgear are in an open position, meaning that the distribution line in question is disconnected from the network.

The housing of the motor operator 7 is an extruded aluminum tube having a cross section as shown in FIG. 11. The ends of the tube are closed with end covers (not shown). The covers are secured with screws received in screw channels in the interior of the tube. On the outside the tube is having dovetail grooves, which could be exploited for mounting purposes. The end covers are steel plates and between the covers and the tube sealings are arranged.

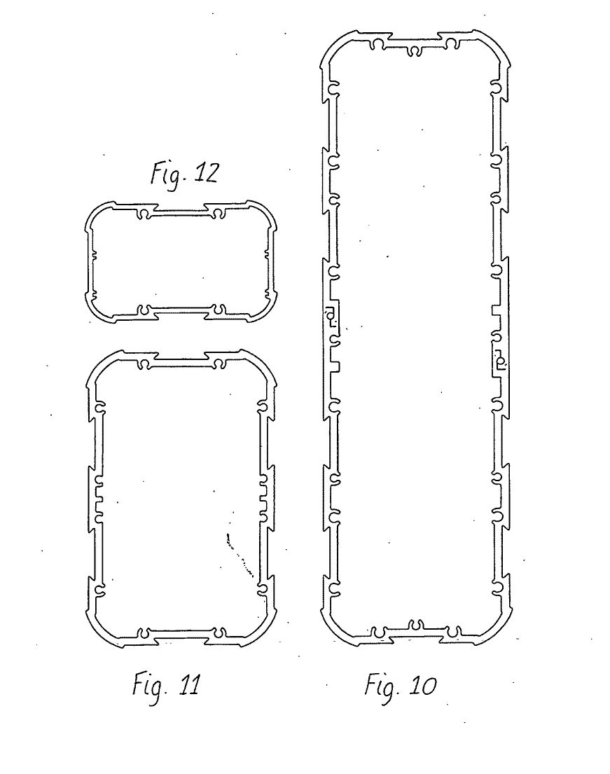

The housing of the other motor operator 6 is constituted by three sub-housing. The first sub-house is identical to the housing of the motor operator 7. The second sub housing contains a rechargeable battery package and said housing being similar to the first sub-housing besides from the fact that is the length is shorter. The third sub-housing holds the electrical equipment such as the control equipment. This sub-housing is also an extruded aluminum tube, the cross section of which is shown in FIG. 10. This sub-housing also has internal screw channels and external dovetail grooves. The cross section of the tube corresponds with the cross section of the tube for the first and second sub-housings besides from that the width is a bit longer than twice the width of these, meaning that the first and second sub-housings could be arranged on top of the third sub-housing. They could be mutually fixed exploiting the internal screw canals or the external dovetails. The open space between the first and the second sub-housing could be closed with a fill-in element, alternative an intermediate bottom could be arranged. An optional fourth sub-housing profile shown in FIG. 12 is designed especially to fit an external cabled modem as a Paknet modem.

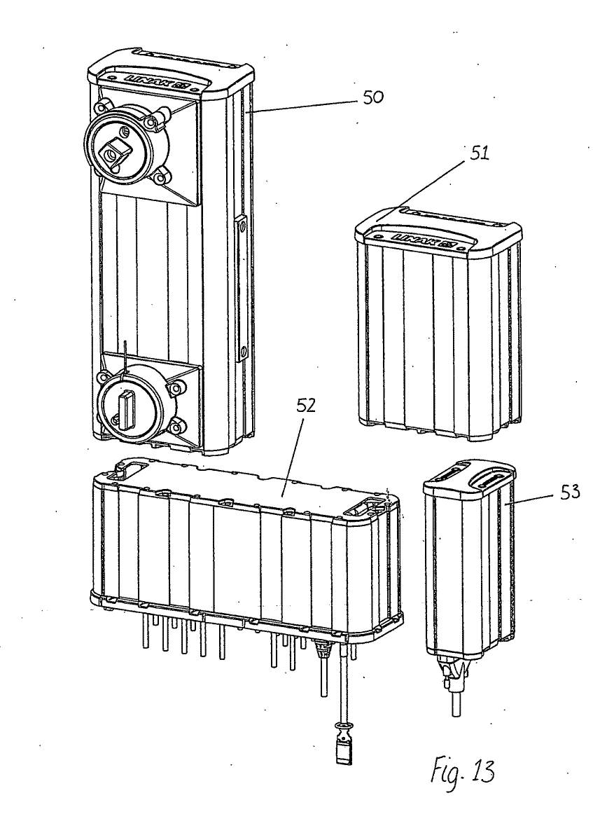

FIG. 13 shows a motor operator for a switchgear with the motor operator sub-housing 50, the battery sub-housing 51, the control unit sub-housing 52 and a sub-housing for an external modem 53.

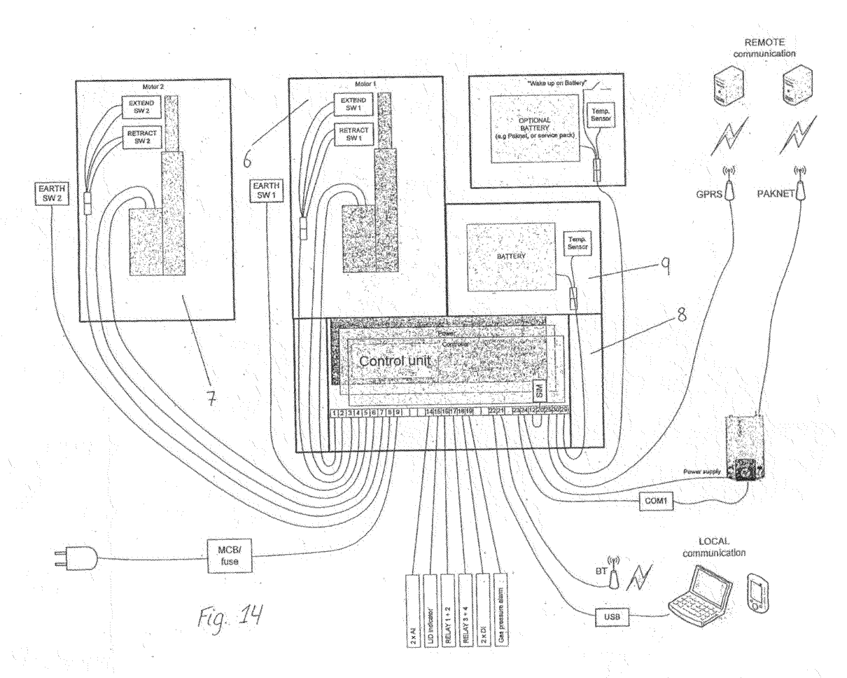

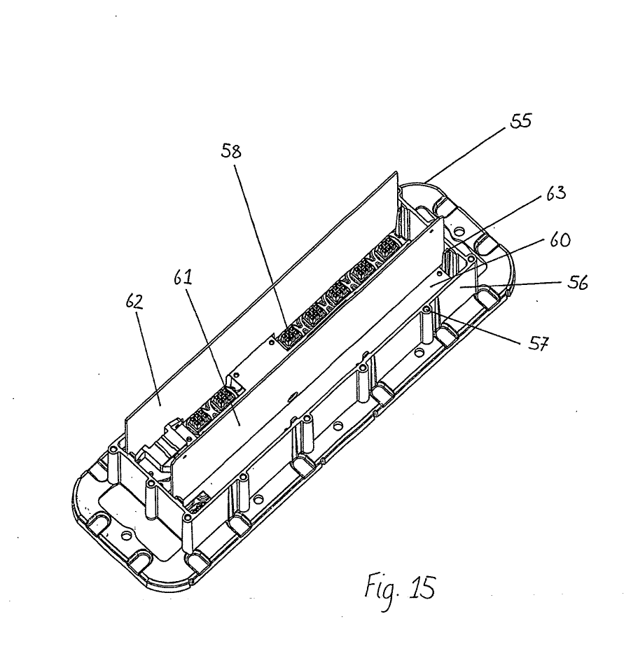

In FIG. 14 is shown an overall lay-out of motor operators, indicating the various possibilities of remote and local controls, and further indicates various power supplies. The icons used in the drawing are self explanatory. For the motor operator 6 an optional further battery package is indicated, located in a sub-housing similar to the sub-housing for the battery package 9 and could be arranged in continuation thereof.

FIG. 15 is showing the end cover 55 for the modular sub-housing, containing the control unit in a special embodiment, where it is used as a mounting rack for the electronic circuits. The end cover 55 is having a wall element 56 build vertical to the end in order to form an enclosing half part of a housing to protect the control unit. Another top part of the housing, not shown, can be mounted with screws in the holes 57. The end cover 55 for the control unit is equipped with a printed circuit board 60 that acts as a backbone, with connections to the connectors 58 to interface the switchgear equipment, hence also establishing connection to the two printed circuit boards placed vertically on the printed circuit board forming the backbone in special sliding means 63 for fixing the printed circuit boards in their position. Said printed circuit boards are the power supply (PSU) 61 and the microprocessor board (CPU) 62 to facilitate the monitoring and control functions of the motor operator for the switchgear. Since it is build in a modular way, a defect printed circuit board can easily be replaced without any soldering on site. A printed circuit board can even be replaced with a new model of the same, possibly adding more (or less) features to the system, with the limitation that this new printed circuit board is equipped with the same interface towards the printed circuit board forming the backbone. A special feature of the PSU is that it is controlled via a data interface, meaning that the CPU can request the PSU to perform specific tasks as e.g. setting up a supply channel to power the actuator or perform a charging task on each of the attached battery packs. Performing a test sequence on the batteries in order to determine the state of health, can also be carried out by the PSU. The PSU also has means to measure the current draw from a supplied device, thus indicating the state of health of that specific component. The measurements are forwarded to the CPU and stored in the flash file system, and can be used to track system degradation with focus on the individual piece of equipment, e.g. the actuator or the battery. A special feature of the PSU is the ability to interface alternative current sources as e.g. a wind turbine or a panel of solar cells. This is made possible with dedicated interfaces or a switch mode converter that bucks or boosts the voltage to a level where charging the battery package is possible.

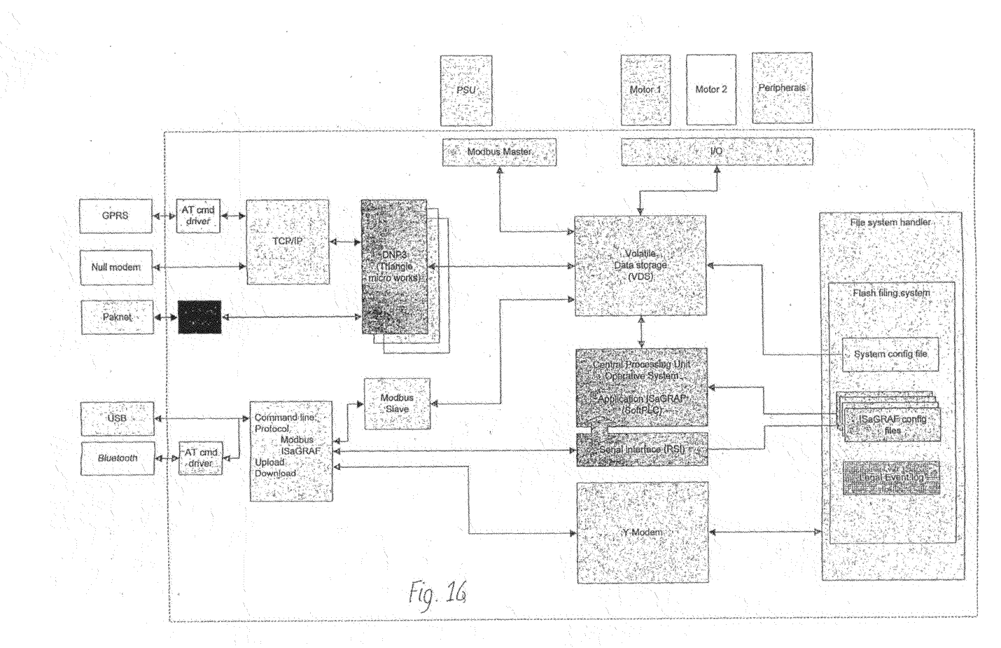

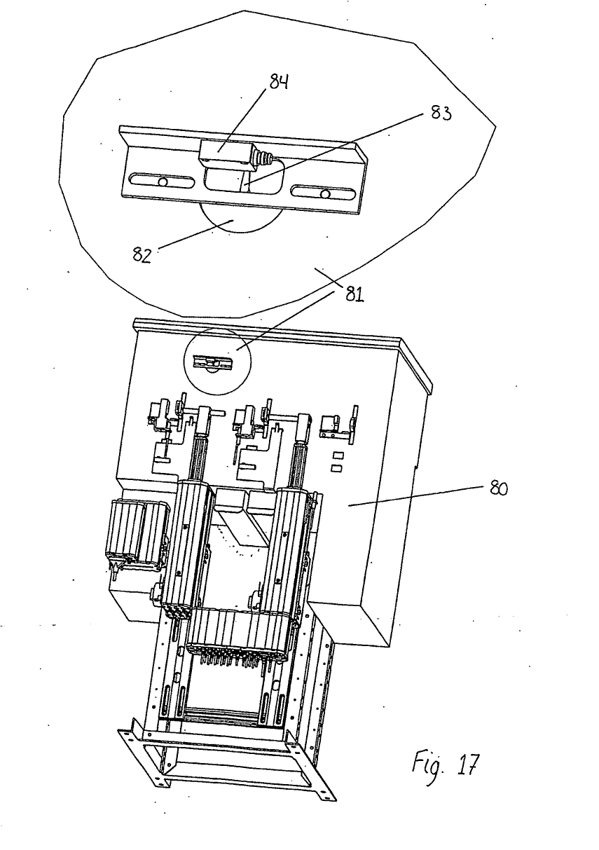

The overall system build up of the control unit is pictured in FIG. 16. The main component in the control unit is the microprocessor (central processing unit). The operative system, here a proprietary software, but could be a known operative software such as Linux, runs the system and supports the application ISaGRAF that in fact is a software emulated PLC hereafter described as a “soft PLC”. When the control unit is switched on, the operative system and the application (SoftPLC) are booted from flash and information from the configuration files are read from the File System via the File System handler. Up and running, said application software will, as a first action, initiate a status check of the switchgear system. The status check of the system is done by checking the status of the Volatile Data Storage (VDS). The VDS is a register that keeps track of the state of the system with means for communicating state changes to the interfaced modules. This could be input or output data from the application software to run the soft PLC or to read or write to the I/O system. The I/O system is build using a FPGA. Since some simple logic facilities, needed in every switchgear control system, are built into the FPGA, it enables fast responses to changes in the system, without the need for processing data in the soft PLC. The functionality is mainly implemented where an ongoing process has to be stopped immediately when a certain event happens, or an illegal action has to be prevented. The main logic interpreter is though the soft PLC, but the soft PLC is not capable of overruling the logic in the FPGA. This build up makes it possible to differentiate, when it comes to functionality, from one switchgear system to another since the logic functions, are set up when the system is booted by reading the system-config file. This file contains the information that characterizes the specific switchgear station setup with its equipment. Since the control unit is build using a register for keeping track of status of the system, together with an application running on the microprocessor to control the logic, the system is build very flexible and will be a long term solution, since it will be possible to develop the system to new demands from the customers by adding more portions of code to the soft PLC, and describing the system changes in the system-config file. It is even possible to change to a new application for running the soft PLC if future needs for this turns up, e.g. if a customer is more familiar with a certain type of application. If the CPU module in the control unit over time does not meet the expectations of the time, a newly developed CPU module, having the same connection interfaces towards the backbone printed circuit board, can be developed and easily fitted to the system. The setup of remote connections with gateways, IP-adresses, usernames and passwords are also described in the system-config file. Connections to the short and wide range remote (short range remote typically: USB; Bluetooth) (wide range remote typically: Cabled connection with Paknet; GSM/GPRS via TCP/IP) are made possible using different communication interfaces and protocols as described in the drawing, with those means it is possible to transfer data between the switchgear system control box and the respective remote terminals. Please note that more protocols are foreseen to be used in the system as indicated by the boxes covered under the box: DNP3 (Triangle micro works) Typically, data in form of information on status of the switchgear, position and state of health of the equipment is sent to the remote terminal, but also on a regular basis a heartbeat signal to show that the motor operator for the switchgear is operable. The heartbeat signal can be initiated from both the remote or the control unit. If initiated from the remote, the control unit sends a response signal. From the remote terminal to the switchgear, it is possible to send upgrades of software to be loaded to the system, requests for changing the position of the switchgear or performing other tasks on the switchgear like running a test to get a picture of the general state of health of the system. It could also be requesting information on the tasks that have been performed in the past, typical when the switchgear have been operated, and by whom. Here a real time clock is needed since it is needed for the timestamp of the legal events. The real-time clock can be a dedicated chip with a battery backup that will keep the device alive even though the power supply has been cut and the battery packs have been drained or disconnected. Preferred the real-time clock will be a radio controlled real-time clock. Requiring the switchgear to change the position of the switch, will reach the VDS via DNP3 or Modbus, and result in a change of the state of the register that corresponds to that feature in the VDS. When the register is read by the soft PLC, the logic will determine what to do and accordingly initiate the task. In case the issued command is to change the position of the switchgear, the first thing will be to request the power supply (PSU) to get ready for driving the actuator. The request is send to the VDS and replicated to the PSU via a modbus command. When the PSU communicates back to the VDS that the supply is present, the VDS will indicate this to the soft PLC by setting the corresponding bits in the register, and the soft PLC will know, when it scans the VDS registers, that the PSU is ready to deliver the requested power, and accordingly reflect with a command to start the movement of the actuator in the wanted and allowed direction. The VDS will take action to carry out the request until it recognizes the indication of that the switchgear has changed position and the actuator has driven the spindle nut, and by this the shaft of the switchgear to a certain position. As earlier mentioned under the description of FIG. 2, the end stop switches can be used to specify a certain and wanted stroke of the actuator that fits the movement of the shaft of the switchgear. In this embodiment shown in FIG. 9, more switches to go with the end stop switches are introduced to indicate not an end stop but a position, thus naming said switches position switches. Between the position switches, we distinguish between the “down” switches that describe the switches to be activated when the actuator is in its retracted position, and “up” switches when the actuator is driven to the extracted position. As there are two position switches in each end of the travel of the actuator, they are referred to as the up 70, upx 71, down 72 and downx 73 switches where the x in the name refer to the extreme positions where the actuator has to be stopped immediately in order not to force the mechanics of the switchgear into positions, where the mechanics can be deformed or broken. The position switches are magnetic activated reed-switches, activated by a magnet attached to the spindle nut in the actuator. As seen in FIG. 9, the position switches in the present embodiment, are mounted in the longitudinal grooves 19a, 19b on the guide tube 19. The nature of the shifting of a switchgear is different to conventional switches, having no valid stable conditions between open and closed and this with an unchanged gap between the poles, whenever the contacting means are not closed. The movement of the contacting means, seen from the shaft, forms a curve with a hysteresis where the three corresponding travels on the linear movement of the shaft can be pointed out to picture respectively the open and closed position of the switchgear and a position in-between, where the position can not be determined. The linear movement of the spindle nut on the travel of the spindle in the actuator is determined by the position switches, where the signaling from said switches triggers the I/O FPGA. In case of signaling from the upx 71 or downx 73 switch, the FPGA immediately terminates the control signal to the actuator because of the build in logic, and indicates, via the VDS, to the soft PLC, that the actuator has shifted the position of the switchgear. In case there is an error in the system and the switchgear has to be shifted manually, the release function of the actuator is activated and the spindle nut will run freely on the spindle. Because of the mentioned characteristics of the movement of the contacting means seen from the shaft, a manual shifting of the switchgear will, because of the mechanical play in the system, not be subject to activating the outer position switch (the upx 71 or downx 73), but only the inner position switch, and thus not give an indication of the position of the switchgear. To overcome this problem, the additional magnetic position switches (up 70 and down 72) are inserted. They are inserted in each end of the linear travel of the spindle nut, where a manual shift of the switchgear will give a reliable indication of the switchgear being in one of the two defined positions. Normally, end stop or position switches are chosen of the reed type magnetic switches, where the closing effect is only achieved and maintained when the magnet is present in the near area of the switch. To be able to indicate the two positions of the switchgear and maintain the indication, when the spindle nut during its travel on the spindle is between the two position switches in each end of the travel (up 70 and upx 71; down 72 and downx 73), a special type of magnetic switch is selected where the switch changes its state when activated by the magnet and maintains its state when the magnet is moved further over and passes on in the same direction and leaving the switch. When the magnet is moved over the same switch in the other direction, the state will be changed. This is an advantage since the two inner switches will always reflect the contacting state of the switchgear even when the control system has been inactive because of a power cut where the switchgear possibly has been shifted manually. When the control system retains its supply, the position of the switchgear, indicated by the system, can be trusted reliably. In this way the present invention is superior to the prior art for determining the position of the spindle nut during the travel of the spindle, and hereby getting the status of the switchgear, since the use of conventional reed switches or encoders will, in case of a power cut and manual shifting of the switchgear, question the reliability of the indication of the switchgear position.

The control unit also interfaces the equipment of the switchgear, as e.g. the gas pressure gauge as shown in FIG. 17. Here a switchgear system of a different embodiment to the previous described is pictured, but a gas pressure gauge could be present on any switchgear system. The details about the gas pressure gauge is shown in the “bubble” 81 and enlarged on top of the figure. As it is of vital interest for the switchgear that the contacting means are protected against burn out by filling the housing with a protecting gas, the level of gas pressure has to be monitored. For a traditional gas pressure gauge 82 with a pointer 83, it can be read by using a laser 84 sending a laser light beam towards a pre selected criteria pressure limit and when the pointer 83 of the gas pressure gauge 82 crosses that limit, an alarm signal is triggered because the distance between the laser 84 sending the laser beam and the background is decreased. Please note that the arrangement can be fitted directly to read the gas pressure gauge without drilling additionally holes in the housing of the switchgear.

1. A motor operator for switchgear for mains power distribution systems, said switchgear comprising a closed cabinet with an operating shaft, the end of which has a coupling means, accessible on the outside of the cabinet, and said operating shaft being rotatable at least between a closed and an open position of the contacts of the switchgear, said power operator comprising,
a housing mountable on the external surface of the switchgear cabinet and containing
a motor driven unit with coupling means for connection with the coupling means of the operating shaft of the switchgear, and
a control unit.

2. The motor operator according to claim 1, wherein the control unit includes a connection rack for connecting
1) the motor driven unit,
2) at least one sensor,
at least one or more of the following power supplies:
3) a mains cable,
4) a mains connected power supply,
5) a solar panel,
6) a wind turbine generator,
7) a battery package.

3. The motor operator according to claim 2, wherein the control unit includes means for recognizing and utilizing the possible attachable power supplies.

4. The motor operator according to claim 2, wherein the control unit includes dedicated interfaces or a switch mode converter that bucks or boosts the voltage to a level where charging of a battery package is possible.

5. The motor operator according to claim 1, wherein the control unit includes connections for connecting at least one or more of the following communication facilities:
1) a wireless connection such as GSM/GPRS,
2) a cable bound connection,
3) a short range wireless communication such as Blue Tooth or WLAN,
4) a cabled short range connection such as USB.

6. The motor operator according to claim 5, wherein the control unit includes means for establishing connections through the possible wired and wireless connections.

7. The motor operator according to claim 1, wherein the control unit includes a central processing unit with interfaces in order to:
1) read status of the system,
2) write and read data from a file system,
3) carry out changes of the position of the switchgear,
4) check system state of reliability,
5) indicate warnings and errors in the system,
6) keep data logging of legal events,
7) establish and maintain connection to remote.

8. The motor operator according to claim 6, wherein the control unit for communicating with a remote unit is using the appropriate communication standard(s) for the specific interface, possibly being at least one of, or more in combination of:
1) TCP/IP,
2) AT CMD,
3). DNP3,
4) Modbus,
5) IEC 870-5,
6) Paknet,
7) Ethernet,
8) GSM/GPRS,
9) UMTS,
10) Bluetooth,
11) Zigbee,
12) WLAN.

9. The motor operator according to claim 1, wherein the control unit interfaces a number of sensors that could be at least one of:
1) gas pressure gauge,
2) magnetic position switch mounted on motor drive,
3) thermo sensor,
4) real time clock such as radio controlled clock,
5) indicators for position of safety locks mounted on the housing of the switchgear,
6) release state indicator for motor drive,
7) laser module for detecting gas pressure level,
8) fault passage indicator,
9) general purpose standard interface such as 0-10 volt voltage or 0-10 mA current loop,
10) serial interface such as RS232
11) pulse width Modulated signal (PWM)

10. The motor operator according to claim 1, wherein the control unit instantaneously will be triggered by the input from the fault passage indicator when a fault occurs to generate a file or a legal event log in a database file containing at least the real time for the event and possibly an indication of the nature of the fault.

11. The motor operator according to claim 7, wherein the control unit because of the data logging of the legal events will be able to track degradation of the system and issue warnings or errors, when certain conditions are met.

12. The motor operator according to claim 1, wherein the control unit includes means for a reliable reading of the position of the switchgear, the movement of the switchgear having been carried out manually or moved by the motor drive, the control unit being powered or cut off from the power supply.

13. The motor operator according to claim 1, wherein the motor driven unit is a linear actuator.

14. The motor operator according to claim 13, wherein the motor driven unit includes at least two position switches, to indicate the position of the switchgear by reading the position of the spindle nut during the travel of the spindle in the actuator.

15. The motor operator according to claim 14, wherein the position switches are magnetically activated switches.

16. The motor operator according to claim 15, wherein at least one of the magnetically activated switches are with a latching effect, said latching effect being subject to permanently activate said switch, when a magnet is moved over said switch in one direction and to deactivate said switch, when a magnet is moved over said switch in the opposite direction.

17. The motor operator according to claim 13 wherein the magnet, to be moved over the magnetic activated switches, follows the movement of the spindle nut during the travel of the spindle in the actuator for said motor operator.

18. The motor operator according to claim 17, wherein the magnet is attached to the spindle nut itself.

19. The motor operator according to claim 17, wherein the magnetic switches are mounted on the part of the housing of the actuator that forms the guide tube.

20. The motor operator according to claim 19, wherein the guide tube of the actuator housing embracing the spindle is equipped with grooves for mounting and positioning the magnetic activated switches in the length of the movement of the spindle nut on the travel of the spindle of said actuator.

21. The motor operator according to claim 1, wherein the control unit includes a main backbone printed circuit board with connectors for connecting at least one printed circuit board.

22. The motor operator according to claim 21, wherein the main backbone printed circuit board interfaces the connections control unit equipped connection rack.

23. The motor operator according to claim 21, wherein the printed circuit board(s) to connect to the main backbone printed circuit board includes the power supply and the central processing unit.

24. The motor operator according to claim 21, wherein the printed circuit board equipped with the central processing unit is equipped with sockets for optionally connecting and supplying at least one wireless communication module.

25. The motor operator according to claim 21, wherein the printed circuit board equipped with the central processing unit is equipped with a socket for a real-time clock circuit or the circuit being embedded directly on said printed circuit board.

26. The motor operator according to claim 25, wherein the real-time clock is a radio controlled real-time clock.

27. The motor operator according to claim 25, wherein the real-time clock is equipped with a backup supply to supply said real-time clock circuit without interrupt.

28. The motor operator according to claim 27, wherein the control system is equipped with an input/output device as, e.g., a FPGA where logic functions are build-in hardware to enable or disable certain outputs when certain input conditions are met without the ability of the central processing unit to overrule said logic functions.

29. The motor operator according to claim 28, wherein the certain inputs are at least one of:
1) actuator position switch,
2) gas pressure gauge low level indication,
3) actuator release is active,
4) earth switch is enabled,
5) battery level inadequate or no supply,
6) fault signals from any of the components in the system,
7) temperature sensor,
8) fault passage indicator,
9) ISaGRAF power available indication.

30. The motor operator according to claim 28, wherein the certain outputs are at least one of:
1) actuator shifting of switchgear,
2) transmission of heartbeat, warnings or errors to remote,
3) setup of power supply for supplying a component in the system,
4) training session on battery packet.

31. The motor operator according to claim 1, wherein the control unit on a regularly basis communicates with the remote to send a heartbeat signal.

32. The motor operator according to claim 1, wherein the control unit from the remote can be updated with new data, such as firmware or configuration files, and be forced to install the updates.

33. The motor operator according to claim 1, wherein the motor driven unit is equipped with interfaces that makes it possible to connect a computer in order to monitor and control the functions build into the control unit.

34. The motor operator according claim 1, wherein the control unit has an interface towards the power supply for communicating the output parameters for said power supply, receiving a confirmation signal when the requested output is present.

35. The motor operator according to claim 8, wherein the control unit in a setup file in the file system reads the information needed to facilitate the communication facilities, such as gateway, IP-addresses, username, and password.

36. The motor operator according to claim 1, wherein the motor driven unit comprises a potentiometer to determine the position of the activation element.

37. The motor operator according to claim 1, wherein the control unit is equipped with a central processing unit comprising software code portions for an operating system and an application for monitoring and controlling the motor drive based on instructions written in a configuration file and the static and dynamic input from the interfaces to the control unit.

38. The motor operator according to claim 1, including a gas pressure alarm.

39. The motor operator according to claim 38, including a gas pressure gauge with a pointer and a laser sending a laser light beam towards a preselected criteria pressure limit and, when the pointer of said gas pressure gauge crosses said preselected limit, an alarm signal is triggered.

40. A method for operating a switchgear with a motor operator according to claim 1, said switchgear having a set of contacts, which could be switched between an on-position, an off-position and an earthing-position, and where the motor operator has a release mechanism by means of which it could be released from the contact set of the switchgear, wherein when the release mechanism for the motor operator is disabled, then the switchgear could only be changed by means of the motor operator, namely between the on-position and the off-position and vise versa.

41. A method for operating a switchgear with a motor operator according to claim 1, said switchgear having a set of contacts which could be switched between an on-position, an off-position and an earthing-position, and where the motor operator has a release mechanism by means of which it could be released from the contact set of the switchgear, wherein when the release mechanism for the motor operator is activated, then the switchgear can only be operated manually, namely between the on-position, the off-position and the earthing-position and vise versa.
